(19) United States
(12) Patent Application Publication
(10) Pub. No.: US 2026/0085982 A1
(43) Pub. Date: Mar. 26, 2026

(54) METHOD FOR COLORIMETRIC TEMPERATURE MEASUREMENT IN ULTRA-HIGH TEMPERATURE ENVIRONMENT BASED ON MULTISOURCE ERROR SELF-CORRECTION

(71) Applicant: UNIVERSITY OF ELECTRONIC SCIENCE AND TECHNOLOGY OF CHINA, Chendgu (CN)

(72) Inventors: Chun YIN, Chengdu (CN); Kai CHEN, Chengdu (CN); Jianqi LIU, Chengdu (CN); Yuhua CHENG, Chengdu (CN); Shibo JIA, Chengdu (CN); Yuanhao ZHANG, Chendgu (CN); Qudong GUO, Chendgu (CN); Chao WANG, Chendgu (CN)

(73) Assignee: UNIVERSITY OF ELECTRONIC SCIENCE AND TECHNOLOGY OF CHINA, Chengdu (CN)

(21) Appl. No.: 19/349,409

(22) Filed: Oct. 3, 2025

(30) Foreign Application Priority Data
Jul. 31, 2025 (CN) 202511068985.6

(51) Int. Cl. G01K 11/12; G01K 15/00

(52) U.S. Cl. CPC G01K 11/12; G01K 15/005

(57) ABSTRACT

The present invention provides a method for colorimetric temperature measurement in ultra-high temperature environment based on multisource error self-correction, which firstly establishes a colorimetric temperature measurement formula, then determines a low-error characteristic curve based on green channel features of N pluralities of calibration images, thus creating a probability model that combines prior knowledge of calibration data with actual observation data in actual measurement, and lastly, performs a iterative optimization based on an established objective function to obtain a corrected temperature, thus the multisource errors are uniformly corrected and the accuracy of colorimetric temperature measurement in ultra-high temperature environment is significantly improved.

### FIELD OF THE INVENTION

This application claims priority under the Paris Convention to Chinese Patent Application No. 202511068985.6, which is filed on Jul. 31, 2025, the entirety of which is hereby incorporated by reference for all purposes as if fully set forth herein.

The present invention relates to the field of non-contact temperature measurement in ultra-high temperature environment, more particularly to a method for colorimetric temperature measurement in ultra-high temperature environment based on multisource error self-correction.

### BACKGROUND OF THE INVENTION

With the development of intelligent manufacturing technology, industrial production processes have imposed higher requirements on the precision of parameter measurement and control. In fields such as aerospace, high-temperature alloy manufacturing and precision welding, accurate temperature measurement directly determines product performance and process stability. In these fields, temperature parameters often directly determine product performance and process stability. Taking next-generation aircraft engine as an example, to improve its thrust-to-weight ratio, the precision and reliability of temperature monitoring have become critical technical indicators.

The importance of temperature monitoring technology is reflected in multiple aspects: First, in aircraft engine, the temperature distribution of turbine blades directly affects their life cycle and safety performance. Second, in spacecraft propulsion system, the accurate measurement of temperature field distribution of a combustion chamber is conducive to optimizing combustion efficiency and improving propulsion performance. Third, in metal welding processes, accurately measuring the surface temperature distribution of a continuous casting billet is conducive to quantitatively analyzing its solidification and heat transfer process, thereby avoiding problems such as internal cracks, surface cracks and bulging.

In the field of ultra-high temperature measurement, temperature measurements can be divided into contact measurement and non-contact measurement. For components such as aircraft engine turbine blades that rotate at high speed and operate in ultra-high temperature environment, traditional contact sensor is difficult to achieve effective measurement and cannot obtain complete temperature field distribution information. In contrast, non-contact temperature measurement based on radiation principle has gained widespread application. Particularly, the colorimetric temperature measurement system with CCD (Charge Coupled Device) sensors as the core captures thermal radiation from an object and converts it into a high-resolution digital image, realizing real-time monitoring of temperature field under the premise of guaranteeing measurement accuracy. The system also has advantages such as wide measurement range and fast response speed, making it become an important tool for high-temperature measurement in various industrial fields.

However, colorimetric temperature measurement faces multiple challenges in practical application: In actual application scenario, object do not perfectly satisfy black body assumption, the emissivity of measured object is uncertain, and environmental disturbance such atmospheric reflection will affect the calculation of radiation ratio, increasing the difficulty of high-precision colorimetric temperature measurement. To solve the above challenges, researchers have proposed various optimizations, which has improved measurement performance to different degrees, but limitations still exist: complex correction models which need complex calibration procedures are introduced in some optimizations, and the computational complexity of some optimizations is too high, making the response speed of colorimetric temperature measurement system slow and unable to meet real-time temperature measurement.

### SUMMARY OF THE INVENTION

The present invention aims to overcome the deficiencies of the prior art, and provides a method for colorimetric temperature measurement in ultra-high temperature environment based on multisource error self-correction, which extracts calibration data features of low self-test errors from each calibration image, identifies an intrinsic correlation pattern between image green channel features and environmental disturbances, then establishes a green channel low-error feature curve, and establishes an objective function based on Bayesian inference. Through iterative optimization solution of the objective function, the multisource errors are uniformly corrected, which significantly improves the accuracy of colorimetric temperature measurement in ultra-high temperature environment and realizes the visualization of two-dimensional temperature field by mapping temperature information to image.

To achieve these objectives, in accordance with the present invention, a method for colorimetric temperature measurement in ultra-high temperature environment based on multisource error self-correction is provided, comprising:
(1). establishing a colorimetric temperature measurement formula: \hat{T}=F(l), where \hat{T} is a measured temperature, l is a colorimetric value, F(l) is a temperature function of colorimetric value l;
(2). determining a low-error characteristic curve based on green channel features of N pluralities of calibration images
2.1). using the colorimetric temperature measurement formula to perform self-tests on the N pluralities of calibration images to obtain temperature self-test results \hat{T}(i, j)=F(l_{i,j}), i=1, 2, . . . , N, j=1, 2 . . . , Mᵢ, where Mᵢ is a number of i^{th} plurality of calibration images acquired at i^{th} temperature Tᵢ, lᵢⱼ is a colorimetric value and:

$${l}_{i , j} = ln ( {\overline{R}}_{i , j} / {\overline{G}}_{i , j} )$$

where R̅_{i,j} is a red channel mean value and G̅_{i,j} is a green channel mean value of a j^{th} calibration image of the i^{th} plurality of calibration images;
2.2). calculating a self-test error E_{i,j} of each calibration image:

$${E}_{i , j} = \vert \hat{T} ( i , j ) - {T}_{i} \vert$$

2.3). choosing a green channel mean value of a calibration image which has minimum self-test error E_{i,j} among the i^{th} plurality of calibration images and denoting the chosen green channel mean value by

$${G}_{{T}_{i}}^{*} ;$$

2.4). determining the low-error characteristic curve

$${\hat{G}}_{T}^{*}$$

by performing a non-linear function fitting based on green channel mean values

$${G}_{{T}_{i}}^{*}$$

and temperature Tᵢ, i=1, 2, . . . , N:

$${\hat{G}}_{T}^{*} = {β}_{g} ( T )$$

where β_{g} is a green channel mean value function of temperature T;
(3). calculating a fitting error σ_{g} between green channel mean values G̅_{i, j} and low-error characteristic curve predications

$${\hat{G}}_{{T}_{i}}^{*} , i = 1 , 2 , … , N , j = 1 , 2 , … , {M}_{i} :$$

$${σ}_{g} = \sqrt{\frac{1}{n - 1} {\sum }_{i = 1}^{N} {\sum }_{j = 1}^{{M}_{i}} {( {\overline{G}}_{i , j} - {\hat{G}}_{{T}_{i}}^{*} )}^{2}} , n = {\sum }_{n = 1}^{N} {M}_{i}$$

where n is a total number of the N pluralities of calibration images, and

$${\hat{G}}_{T}^{*} = = {β}_{g} ( T )$$

(4). calculating an error σᵢ between temperature self-test results \hat{T}(i, j) and true temperatures, namely temperatures Tᵢ, i=1, 2, . . . , N, j=1, 2, . . . . Mᵢ:

$${σ}_{t} = \sqrt{\frac{1}{n - 1} {\sum }_{i = 1}^{N} {\sum }_{j = 1}^{{M}_{i}} {E}_{i , {j}^{2}}}$$

(5). acquiring a RGB image, namely a test image Pₜₑₛₜ from a test workpiece in ultra-high temperature environment by using an industrial digital camera with charge-coupled device image sensors, denoting red channel value and green channel value of pixel (u,v) of test image Pₜₑₛₜ by R_{(u,v)} and G_{(u,v)} respectively, and calculating colorimetric value l_{(u,v)}:

$${l}_{( u , v )} = ln ( {R}_{( u , v )} / {G}_{( u , v )} )$$

(6). establishing an objective function L(G,T,l) based on Bayesian inference:

$$L ( G , T , l ) = \frac{{( G - {β}_{s} ( T ) )}^{2}}{2 {σ}_{g}^{2}} + \frac{{( F ( l ) - T )}^{2}}{2 {σ}_{t}^{2}}$$

where G is a green channel value;
(7). iteratively calculating a corrected temperature
7.1). calculating an initial temperature

$${T}_{0}^{test}$$

based on the colorimetric temperature measurement formula

$${T}_{0}^{test} = F ( {l}_{( u , ν )} ) ,$$

initializing iteration number k=1, green channel initial value

$${G}_{0}^{test} = {G}_{( u , v )} ,$$

colorimetric initial value

$${l}_{0}^{test} = {l}_{( u , v )} ;$$

7.2). iteratively updating corrected temperature
7.2.1). calculating first momentum mₖ and second momentum vₖ:

$${m}_{k} = {β}_{1} {m}_{k - 1} + ( 1 - {β}_{1} ) \frac{\partial L ( G , T , l )}{\partial T} \vert \begin{matrix}T = {T}_{k - 1}^{test} \\ G = {G}_{k - 1}^{test} \\ l = {l}_{k - 1}^{test}\end{matrix}$$

$${v}_{k} = {β}_{2} {v}_{k - 1} + ( 1 - {β}_{2} ) \frac{{\partial }^{2} L ( G , T , l )}{\partial {T}^{2}} \vert \begin{matrix}T = {T}_{k - 1}^{test} \\ G = {G}_{k - 1}^{test} \\ l = {l}_{k - 1}^{test}\end{matrix}$$

where β₁ and β₂ are momentum coefficients, the initial values of first momentum mₖ and second momentum vₖ are 0, namely m₀=0, v₀=0;
7.2.2). calculating bias corrections:

$${\hat{m}}_{k} = \frac{{m}_{k}}{1 - {β}_{1}^{k}}$$

$${\hat{v}}_{k} = \frac{{v}_{k}}{1 - {β}_{2}^{k}}$$

where \hat{m}ₖ is a bias correction of first momentum mₖ, \hat{v}ₖ is a bias correction of second momentum vₖ;
7.2.3). performing a temperature update:

$${T}_{k}^{t e s t} = {T}_{k - 1}^{t e s t} - {α}_{1} \frac{{\hat{m}}_{k}}{ε + \sqrt{{\hat{v}}_{k}}}$$

where

$${T}_{k}^{t e s t}$$

is k^{th} iteration's corrected temperature, α₁ is a learning rate of temperature update, ε is a constant which is used to prevent denominator from being zero;
7.3). iteratively correcting colorimetric value
7.3.1). calculating square sum

$${v}_{k}^{′}$$

of historical gradients through exponentially weighted moving average:

$${{v}^{′}}_{k} = β {v}_{k - 1}^{′} + ( 1 - β ) {( \frac{\partial L ( G , T , l )}{\partial l} \vert \begin{matrix}T = {T}_{k - 1}^{test} \\ G = {G}_{k - 1}^{test} \\ l = {l}_{k - 1}^{test}\end{matrix} )}^{2}$$

where β is a weight smoothing coefficient, square sum's initial value

$${v}_{0}^{′} = 0 ;$$

7.3.2). correcting colorimetric value

$${l}_{k}^{test} = {l}_{k - 1}^{test} - {α}_{2} \frac{1}{\sqrt{ε + {v}_{k - 1}^{′}}} \frac{\partial L ( G , T , l )}{\partial l} \vert \begin{matrix}T = {T}_{k - 1}^{test} \\ G = {G}_{k - 1}^{test} \\ l = {l}_{k - 1}^{test}\end{matrix}$$

where β₂ is a learning rate of colorimetric value correction;
7.4). iteratively updating green channel value:

$${G}_{k}^{t e s t} = {G}_{k - 1}^{t e s t} + {α}_{3} ( {β}_{g} ( {T}_{k - 1}^{t e s t} ) - {G}_{k - 1}^{t e s t} )$$

where α₃ is a learning rate of update;
7.5). k=k+1, repeating steps 7.2˜7.4, until variation of the objective function L(G,T,l) before and after the k^{th} iteration is less that a set threshold θ:

$$L ( {G}_{k}^{t e s t} , {T}_{k}^{t e s t} , {l}_{k}^{t e s t} ) - L ( {G}_{k - 1}^{t e s t} , {T}_{k - 1}^{t e s t} , {l}_{k - 1}^{t e s t} ) < θ$$

or iteration number k reaches a maximum iteration number, then taking the k^{th} iteration's corrected temperature

$${T}_{k}^{t e s t}$$

as a colorimetric temperature measurement's output, namely a measured temperature.

The objectives of the present invention are realized as follows:

In accordance with the present invention, a method for colorimetric temperature measurement in ultra-high temperature environment based on multisource error self-correction is provided, which firstly establishes a colorimetric temperature measurement formula, then determines a low-error characteristic curve based on green channel features of N pluralities of calibration images, thus creating a probability model that combines prior knowledge of calibration data with actual observation data in actual measurement, and lastly, performs a iterative optimization based on an established objective function to obtain a corrected temperature, thus the multisource errors are uniformly corrected and the accuracy of colorimetric temperature measurement in ultra-high temperature environment is significantly improved;

Furthermore, the method for colorimetric temperature measurement in ultra-high temperature environment based on multisource error self-correction of the present invention has the following advantages:

### 1. Significantly Improving the Temperature Measurement Accuracy in in Ultra-High Temperature Environment

By extracting calibration data features of low self-test errors from each calibration image, the present invention identifies an intrinsic correlation pattern between image green channel features and environmental disturbances, and then establishes a green channel low-error feature curve, and establishes an objective function based on Bayesian inference. Through iterative optimization solution of the objective function, the multisource errors are uniformly corrected, which significantly improves the accuracy of colorimetric temperature measurement in ultra-high temperature environment.

### 2. Low Deployment Cost

The present invention is based on widely applied colorimetric temperature measurement algorithms, does not make any mechanistic correction to the physical processes related to colorimetric temperature measurement and does not require any additional hardware equipment, only needs to add some extra calculation steps of parameter calibration to the existing colorimetric temperature measurement system to correct its output. Therefore, the present invention is easy to deploy and easily integrated into the existing colorimetric temperature measurement system.

### 3. Visualization Capability

The present invention has realized visualization of two-dimensional temperature field by mapping temperature information to image. Through pseudo-color image acquisition, user can clearly observe temperature distribution and dynamic temperature changes, facilitating user's research and temperature monitoring.

### 4. Widely Applicable Fields

The present invention, as a non-contact high-precision temperature measurement in ultra-high temperature environment, is suitable for various ultra-high temperature industrial scenarios, can be used in aerospace components, metal welding and other fields which require temperature's visual detection, providing efficient assistance for the processes such as industrial production, scientific research in the above fields.

### BRIEF DESCRIPTION OF THE DRAWING

The above and other objectives, features and advantages of the present invention will be more apparent from the following detailed description taken in conjunction with the accompanying drawings, in which:

FIG. 1 is a flow diagram of a method for colorimetric temperature measurement in ultra-high temperature environment based on multisource error self-correction in accordance with the present invention;

FIG. 2 is an illustration of some calibration images;

FIG. 3 is an illustration of low-error characteristic curve;

FIG. 4 is an illustration of curves of the colorimetric temperature measurement's average errors and maximum errors which vary over iterations;

FIG. 5 is an illustration of curves of the temperature measurement errors before and after the optimization of colorimetric temperature measurement;

FIG. 6 is a pseudo-color map inverted by a temperature field.

### DETAILED DESCRIPTION OF THE PREFERRED EMBODIMENT

Hereinafter, preferred embodiments of the present invention will be described with reference to the accompanying drawings. It should be noted that the similar modules are designated by similar reference numerals although they are illustrated in different drawings. Also, in the following description, a detailed description of known functions and configurations incorporated herein will be omitted when it may obscure the subject matter of the present invention.

In colorimetric temperature measurement technology, most of existing researches focus on optimizing temperature measurement model, and does not focus enough on the rich information contained in image data. In fact, the temperature variation in industrial scenario often has a specific pattern, which is conducive to associating the response characteristic of CCD sensor to environmental factors, so as to compensate the measurement error. Therefore, it has important research value to establish corresponding compensation algorithm by mining data features and revealing the intrinsic correlation between data features and environmental interferences.

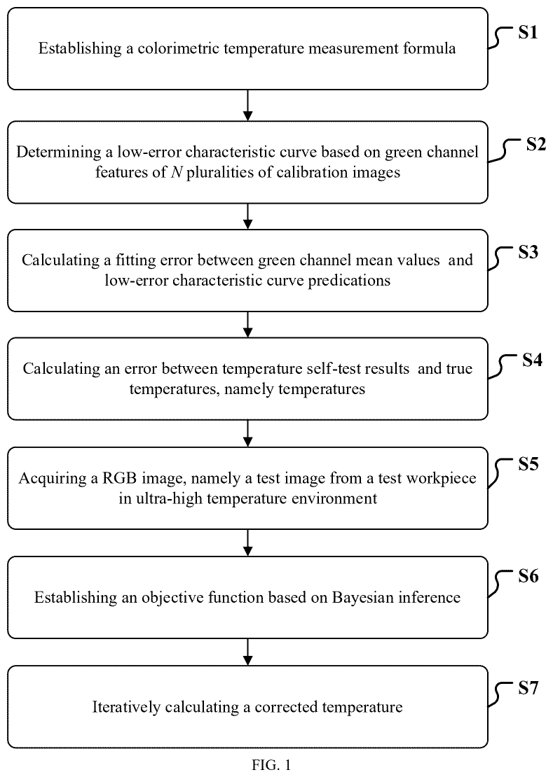

FIG. 1 is a flow diagram of a method for colorimetric temperature measurement in ultra-high temperature environment based on multisource error self-correction in accordance with the present invention.

In one embodiment, as shown in FIG. 1, a method for colorimetric temperature measurement in ultra-high temperature environment based on multisource error self-correction in accordance with the present invention is provided, comprising the following steps:
Step S1: establishing a colorimetric temperature measurement formula

In the embodiment, establishing colorimetric temperature measurement formula: \hat{T}=F(l) is:
heating the calibration workpiece by a blackbody furnace, and acquiring a plurality of RGB images, namely calibration images at i^{th} temperature Tᵢ, i=1, 2, . . . , N by an industrial digital camera with charge-coupled device image sensors in the process of heating, then establishing a colorimetric temperature measurement formula:

$$\hat{T} = F ( l ) = \frac{{c}_{2} ( {λ}_{g}^{- 1} - {λ}_{r}^{- 1} )}{l + {f}_{K} ( l ) + 5 ln ( {λ}_{r} \cdot {λ}_{g}^{- 1} )}$$

where \hat{T} is a measured temperature, l is a colorimetric value, F(l) is a temperature function of colorimetric value l, c₂ is a second radiation constant, λᵣ and λᵣ are standard wavelengths of red band and green band respectively, f_{K}(l) is a temperature response parameter function of colorimetric value l.

Specifically, establishing a colorimetric temperature measurement formula comprises the following steps:
Step S1.1: acquiring N pluralities of calibration images
heating the calibration workpiece by a blackbody furnace, choosing N temperatures in the process of heating, and acquiring a plurality of RGB images, namely calibration images at i^{th} temperature Tᵢ, i=1, 2, . . . , N, by an industrial digital camera with charge-coupled device image sensors. The number of i^{th} plurality of calibration images acquired at i^{th} temperature Tᵢ is denoted by Mᵢ, and the j^{th} calibration image acquired at temperature Tᵢ is denoted by P_{i,j}. Some calibration images are shown in FIG. 2.
Step S1.2: performing a parameter calibration by the N pluralities of calibration images, and establishing the colorimetric temperature measurement formula
Step S1.2.1: extracting target object contour in calibration image P_{i,j}, and recording an area within the contour as target image V_{i,j}.
Step S1.2.2: calculating a red channel mean value R̅_{i, j} and a green channel mean value G̅_{i, j} of all pixels within target image V_{i,j}, respectively. Thus, a colorimetric value denoted by l_{i,j} can be calculated by the red channel mean value and the green channel mean value:

$${l}_{i , j} = ln ( {\overline{R}}_{i j} / {\overline{G}}_{i , j} )$$

Thus, a data pair of colorimetric value and temperature can be obtained: (l_{i,j}, Tᵢ).
Step S1.2.3: calculating a temperature response parameter K_{i,j} according to data pair (l_{i,j}, Tᵢ):

$${K}_{i j} = \frac{{c}_{2} ( {λ}_{g}^{- 1} - {λ}_{r}^{- 1} )}{{T}_{i}} - {l}_{i , j} - 5 ln ( {λ}_{r} \cdot {λ}_{g}^{- 1} )$$

where c₂ is a second radiation constant, λᵣ and λᵣ are standard wavelengths of red band and green band respectively. Thus, a data pair of colorimetric value and temperature response parameter can be obtained: (l_{i,j}, K_{i,j}).
Step S1.2.4: repeating steps S1.2.1˜S1.2.3 for each calibration image to obtain all data pairs (l_{i,j}, K_{i,j}), i=1, 2, . . . , N, j=1, 2, . . . , Mᵢ, and performing a nonlinear function fitting on all data pairs (l_{i,j}, K_{i,j}), a temperature response parameter function of colorimetric value can be obtained: \hat{K}=f_{K}(l), where l is a colorimetric value, \hat{K} is a temperature response parameter, f_{K}(l) is the temperature response parameter function of colorimetric value l.
Step S1.2.5: establishing the colorimetric temperature measurement formula:

$$\hat{T} = F ( l ) = \frac{{c}_{2} ( {λ}_{g}^{- 1} - {λ}_{r}^{- 1} )}{l + {f}_{K} ( l ) + 5 ln ( {λ}_{r} \cdot {λ}_{g}^{- 1} )}$$

Step S2: determining a low-error characteristic curve based on green channel features of N pluralities of calibration images
Step S2.1: using the colorimetric temperature measurement formula to perform self-tests on the N pluralities of calibration images to obtain temperature self-test results \hat{T}(i, j):

$$\hat{T} ( i , j ) = F ( {l}_{i , j} ) = \frac{{c}_{2} ( {λ}_{g}^{- 1} - {λ}_{r}^{- 1} )}{{l}_{i , j} + {f}_{K} ( {l}_{i , j} ) + 5 ln ( {λ}_{r} \cdot {λ}_{g}^{- 1} )} , i = 1 , 2 , … , N , j = 1 , 2 … , {M}_{i}$$

where Mᵢ is a number of i^{th} plurality of calibration images acquired at i^{th} temperature Tᵢ, lᵢⱼ is a colorimetric value and:

$${l}_{j} = ln ( {\overline{R}}_{i , j} / {\overline{G}}_{i , j} )$$

where R̅_{i,j} is a red channel mean value and G̅_{i, j} is a green channel mean value of a j^{th} calibration image of the i^{th} plurality of calibration images.
Step S2.2: calculating a self-test error E_{i,j} of each calibration image:

$${E}_{i , j} = \vert \hat{T} ( i , j ) - {T}_{i} \vert$$

Step S2.3: choosing a green channel mean value of a calibration image which has minimum self-test error E_{i,j} among the i^{th} plurality of calibration images and denoting the chosen green channel mean value by

$${G}_{{T}_{i}}^{*} .$$

Step S2.3: determining the low-error characteristic curve

$${\hat{G}}_{T}^{*}$$

by performing a non-linear function fitting based on green channel mean values

$${G}_{{T}_{i}}^{*}$$

and temperature Tᵢ, i=1, 2, . . . , N:

$${\hat{G}}_{T}^{*} = {β}_{g} ( T )$$

where β_{g} is a green channel mean value function of temperature T.

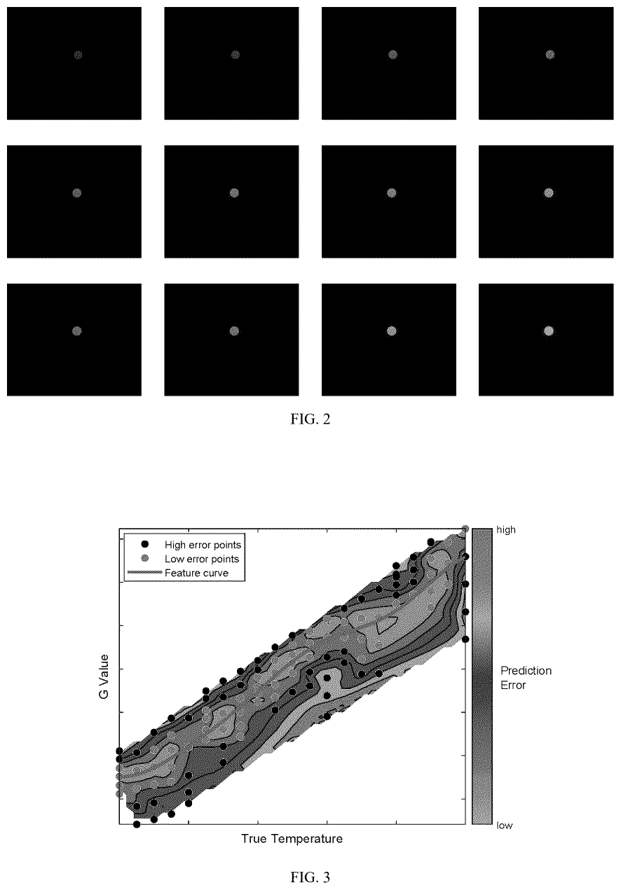

In the embodiment, a low-error characteristic curve is shown in FIG. 3, which shows that although the colorimetric parameters obtained at the same temperature are relatively concentrated, there is still a certain degree of fluctuation of the colorimetric parameters. And among them, the colorimetric parameters which green channel mean values satisfy a specific condition exhibit lower measurement errors.

In temperature-green channel mean value graph, namely G value projection graph which is also shown in FIG. 3, we mark out the point (denoted by

$${p}_{T}^{*}$$

of minimal measurement error at each temperature by gray box, its corresponding green channel mean number value is denoted by

$${G}_{T}^{*} .$$

data analysis shows that the distribution of measurement errors at each temperature is closely related to its green channel mean value, the calibration image which green channel mean value is closer to

$${G}_{T}^{*}$$

exhibits lower measurement error. We can obtain a T-G feature curve of lower error by connecting the points marked by orange boxes, the T-G feature curve reflects the common characteristic of high-precision measurement images: the closer the green channel mean value of an image is to the T-G feature curve, the lower the measurement error of the image will be.
Step S3: calculating a fitting error σ_{g} between green channel mean values G̅_{i, j} and low-error characteristic curve predications

$${\hat{G}}_{{T}_{i}}^{*} , i = 1 , 2 , … , N , j = 1 , 2 , … , {M}_{i} :$$

$${σ}_{g} = \sqrt{\frac{1}{n - 1} {{\sum }_{i = 1}}^{N} {{\sum }_{j = 1}}^{{M}_{i}} {( {\overline{G}}_{i , j} - {\hat{G}}_{{T}_{i}}^{*} )}^{2}}$$

where n is a total number of the N pluralities of calibration images, and

$${\hat{G}}_{{T}_{i}}^{*} ⩵ {β}_{g} ( {T}_{i} ) .$$

Step S4: calculating an error σᵢ between temperature self-test results \hat{T}(i, j) and true temperatures, namely temperatures Tᵢ, i=1, 2, . . . , N, j=1, 2, . . . . Mᵢ:

$${σ}_{t} = \sqrt{\frac{1}{n - 1} {{\sum }_{i = 1}}^{N} {{\sum }_{j = 1}}^{{M}_{i}} {E}_{i , j}^{2}} , n = {{\sum }_{n = 1}}^{N} {M}_{i}$$

Step S5: acquiring a RGB image, namely a test image Pₜₑₛₜ from a test workpiece in ultra-high temperature environment by using an industrial digital camera with charge-coupled device image sensors, denoting red channel value and green channel value of pixel (u,v) of test image Pₜₑₛₜ by R_{(u,v)} and G_{(u,v)} respectively, and calculating colorimetric value l_{(u,v)}:

$${l}_{( u , v )} = ln ( {R}_{( u , v )} / {G}_{( u , v )} )$$

Step S6: establishing an objective function L(G,T,l) based on Bayesian inference:

$$L ( G , T , l ) = \frac{{( G - {β}_{g} ( T ) )}^{2}}{2 {σ}_{g}^{2}} + \frac{{( F ( l ) - T )}^{2}}{2 {σ}_{t}^{2}}$$

where G is a green channel value.

The posterior probability of characterizing a test image's information can be denoted by P(T^{test}|l_{u, v}, G_{u,v}), it is a probability that the real temperature equals to T^{test} under the condition of obtaining colorimetric value l_{(u,v)} and green channel value G_{(u,v)}, respectively, and can be expressed as follows:

$$P ( {T}^{test} \vert {l}_{( u , v )} , {G}_{( u , v )} ) ∝ \frac{1}{\sqrt{2 {πσ}_{g}^{2}}} {e}^{( - \frac{{( {G}_{( u , v )} - {β}_{g} ( {T}^{test} ) )}^{2}}{2 {σ}_{g}^{2}} )} \frac{1}{\sqrt{2 {πσ}_{t}^{2}}} {e}^{( - \frac{{( F ( {l}_{( u , v )} ) - {T}^{test} )}^{2}}{2 {σ}_{t}^{2}} )} {\vert \frac{\partial l}{\partial F ( l )} \vert}_{l = {l}_{( u , v )}}$$

According to the expression of posterior probability, we can obtain the objective function L(G,T,l).
Step S7: iteratively calculating a corrected temperature
Step S7.1: calculating an initial temperature

$${T}_{0}^{test}$$

based on the colorimetric temperature measurement formula

$${T}_{0}^{t e s t} = F ( {l}_{( u , v )} ) ,$$

initializing iteration number k=1, green channel initial value

$${G}_{0}^{t e s t} = {G}_{( u , v )} ,$$

colorimetric initial value

$${l}_{0}^{t e s t} = {l}_{( u , v )} .$$

Step S7.2: iteratively updating corrected temperature by using an Adam optimizer
Step S7.2.1: calculating first momentum mₖ and second momentum vₖ:

$$\begin{matrix}{m}_{k} = {β}_{1} {m}_{k - 1} + ( 1 - {β}_{1} ) \frac{\partial L ( G , T , l )}{\partial T} \vert \begin{matrix}T = {T}_{k - 1}^{test} \\ G = {G}_{k - 1}^{test} \\ l = {l}_{k - 1}^{test}\end{matrix} \\ {v}_{k} = {β}_{2} {v}_{k - 1} + ( 1 - {β}_{2} ) \frac{{\partial }^{2} L ( G , T , l )}{\partial {T}^{2}} \vert \begin{matrix}T = {T}_{k - 1}^{test} \\ G = {G}_{k - 1}^{test} \\ l = {l}_{k - 1}^{test}\end{matrix}\end{matrix}$$

where β₁ and β₂ are momentum coefficients, the initial values of first momentum mₖ and second momentum vₖ are 0, namely m₀=0, v₀=0.
Step S7.2.2: calculating bias corrections:

$$\begin{matrix}{\hat{m}}_{k} = \frac{{m}_{k}}{1 - {β}_{1}^{k}} \\ {\hat{v}}_{k} = \frac{{v}_{k}}{1 - {β}_{2}^{k}}\end{matrix}$$

where \hat{m}ₖ is a bias correction of first momentum \hat{m}ₖ, \hat{v}ₖ is a bias correction of second momentum vₖ.
Step S7.2.3: performing a temperature update:

$${T}_{k}^{t e s t} = {T}_{k - 1}^{t e s t} - {α}_{1} \frac{{\hat{m}}_{k}}{ε + \sqrt{{\hat{v}}_{k}}}$$

where

$${T}_{k}^{t e s t}$$

is k^{th} iteration's corrected temperature, α₁ is a learning rate of temperature update, ε is a constant which is used to prevent denominator from being zero.
Step S7.3: iteratively correcting colorimetric value by RMSPro optimizer
Step S7.3.1: calculating square sum

$${v}_{k}^{’}$$

of historical gradients through exponentially weighted moving average:

$${v}_{k}^{’} = β {v}_{k - 1}^{’} + ( 1 - β ) {( \frac{\partial L ( G , T , l )}{\partial l} \vert \begin{matrix}T = {T}_{k - 1}^{test} \\ G = {G}_{k - 1}^{test} \\ l = {l}_{k - 1}^{test}\end{matrix} )}^{2}$$

where β is a weight smoothing coefficient, square sum's initial value

$${v}_{0}^{’} = 0.$$

In the embodiment, the range of weight smoothing coefficient β is from 0.9 to 0.99.
Step S7.3.2: correcting colorimetric value

$${l}_{k}^{test} = {l}_{k - 1}^{test} - {α}_{2} \frac{1}{\sqrt{ε + {v}_{k - 1}^{’}}} \frac{\partial L ( G , T , l )}{\partial l} \vert \begin{matrix}T = {T}_{k - 1}^{test} \\ G = {G}_{k - 1}^{test} \\ l = {l}_{k - 1}^{test}\end{matrix}$$

where β₂ is a learning rate of colorimetric value correction.
Step S7.4: iteratively updating green channel value:

$${G}_{k}^{t e s t} = {G}_{k - 1}^{t e s t} + {α}_{3} ( {β}_{g} ( {T}_{k - 1}^{t e s t} ) - {G}_{k - 1}^{t e s t} )$$

where α₃ is a learning rate of update.
Step S7.5: k=k+1, repeating steps S7.2˜S7.4, until variation of the objective function L(G,T,l) before and after the k^{th} iteration is less that a set threshold θ:

$$L ( {G}_{k}^{t e s t} , {T}_{k}^{t e s t} , {l}_{k}^{t e s t} ) - L ( {G}_{k - 1}^{t e s t} , {T}_{k - 1}^{t e s t} , {l}_{k - 1}^{t e s t} ) < θ$$

or iteration number k reaches a maximum iteration number, then taking the k^{th} iteration's corrected temperature

$${T}_{k}^{t e s t}$$

as a colorimetric temperature measurement's output, namely a measured temperature.

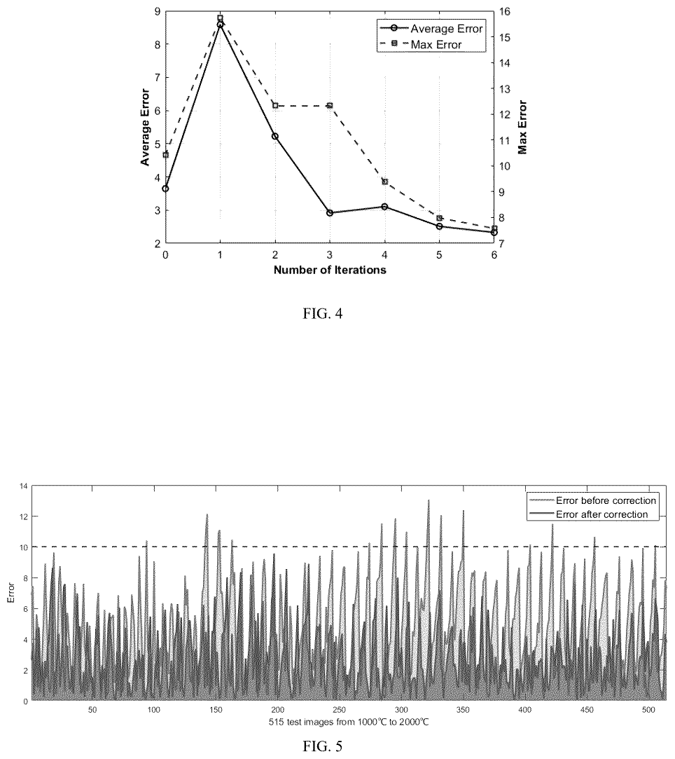

In the embodiment, we conduct experiments on 515 test images, and the curves of the colorimetric temperature measurement's average errors and maximum errors which vary over iterations are shown in FIG. 4. From FIG. 4, we can see that the colorimetric temperature measurement's average errors and maximum errors converge to lower values at the end, and as the iteration progresses, the colorimetric temperature measurement's average errors and maximum errors rise at the beginning. This phenomenon reflects the global exploration of the algorithm, which temporarily leave the current local optimal solution to find a better solution. However, in the subsequent iterations, the colorimetric temperature measurement's average errors and maximum errors decrease continuously, until they converge to a lower level. Therefore, although the system performance temporarily decreases in the early stages of the iteration, it creates conditions for finding better solutions in the future.

In order to show the performance improvement of the present invention, comparing with traditional colorimetric temperature measurement, in FIG. 5, the error accuracy requirement of ±10° C. is indicated by a dashed line, and the temperature measurement error of the traditional colorimetric temperature measurement is shown in light gray, the dark gray part shows the temperature measurement error of the present invention. The experimental results in the embodiment demonstrate that comparing to traditional colorimetric temperature measurement, the present invention has significantly improved the measurement accuracy: the average inversion error has dropped from 4.6312° C. to 2.521904° C. (a reduction of 39.7%), and the maximum error has decreased from 13.07° C. to 8.62828° C. (a reduction of 34.0%), realizing comprehensive compliance with precision requirements. The pass rate (proportion of the samples of less than 10° C.) has increased from 95.92% to 100%, and the average error is significantly better than the accuracy threshold, greatly enhancing the stability and precision of colorimetric temperature measurement system.

To further verify the capability of real-time temperature field inversion of the present invention, we conduct a temperature field inversion experiment by using an image of a blackbody furnace taken at 2000° C.: feeding the image into a calibrated iterative temperature optimization system (created according to the Step S5˜S7) of the present invention for inversion. To reduce the impact of image noise, we calculate the colorimetric value of each pixel based on the color information of its neighboring region. Specifically, a 3×3 neighborhood centered on the target pixel (excluding background pixels) is used, and the average value of pixels within the 3×3 neighborhood is used to calculate a colorimetric value, which is assigned to the center pixel. By traversing the entire target area, we obtained a colorimetric value and a green channel value for each pixel.

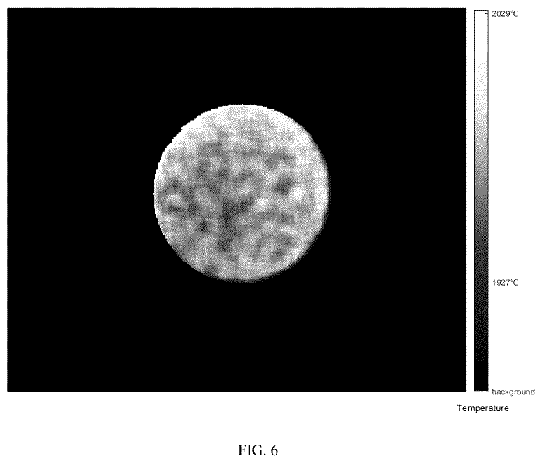

By using the probabilistic model established during calibration, we perform iterative optimization on the objective function to obtain the temperature inversion result for each pixel. The final pseudo-color map of the temperature field is shown in FIG. 6. A total of 8998 pixels within the target area are inverted, where the maximum temperature inversion result is 2029.12° C., the minimum temperature inversion result is 1927.68° C., the average temperature inversion result is 2000.14° C., the standard deviation of temperature inversion results is 9.21° C. From the above temperature inversion results, we can see that an efficient and accurate temperature inversion is realized.

While illustrative embodiments of the invention have been described above, it is, of course, understand that various modifications will be apparent to those of ordinary skill in the art. Such modifications are within the spirit and scope of the invention, which is limited and defined only by the appended claims.

What is claimed is:

1. A method for colorimetric temperature measurement in ultra-high temperature environment based on multisource error self-correction, comprising:
(1). establishing a colorimetric temperature measurement formula: \hat{T}=F(l), where \hat{T} is a measured temperature, l is a colorimetric value, F(l) is a temperature function of colorimetric value l;
(2). determining a low-error characteristic curve based on green channel features of N pluralities of calibration images
2.1). using the colorimetric temperature measurement formula to perform self-tests on the N pluralities of calibration images to obtain temperature self-test results \hat{T}(i, j)=F(l_{i,j}), i=1, 2, . . . , N, j=1, 2 . . . , Mᵢ, where Mᵢ is a number of i^{th} plurality of calibration images acquired at i^{th} temperature Tᵢ, lᵢⱼ is a colorimetric value and:
$${l}_{i , j} = ln ( {\overline{R}}_{i , j} / {\overline{G}}_{i , j} )$$
where R̅_{i, j} is a red channel mean value and G̅_{i, j} is a green channel mean value of a j^{th} calibration image of the i^{th} plurality of calibration images;
2.2). calculating a self-test error E_{i,j} of each calibration image:
$${E}_{i , j} = \vert \hat{T} ( i , j ) - {T}_{i} \vert$$
2.3). choosing a green channel mean value of a calibration image which has minimum self-test error E_{i,j} among the i^{th} plurality of calibration images and denoting the chosen green channel mean value by
$${G}_{Ti}^{*} ;$$
2.4). determining the low-error characteristic curve
$${\hat{G}}_{T}^{*}$$
by performing a non-linear function fitting based on green channel mean values
$${G}_{Ti}^{*}$$
and temperature Tᵢ, i=1, 2, . . . , N:
$${\hat{G}}_{T}^{*} = {β}_{g} ( T )$$
where β_{g} is a green channel mean value function of temperature T;
(3). calculating a fitting error σ_{g} between green channel mean values G̅_{i, j} and low-error characteristic curve predications
$${\hat{G}}_{{T}_{i}}^{*} , i = 1 , 2 , … , N , j = 1 , 2 , … , {M}_{i} :$$
$${σ}_{g} = \sqrt{\frac{1}{n - 1} {\sum }_{i = 1}^{N} {\sum }_{j = 1}^{{M}_{i}} {( {\overline{G}}_{i , j} - {\hat{G}}_{Ti}^{*} )}^{2}} , n = {\sum }_{n = 1}^{N} {M}_{i}$$
where n is a total number of the N pluralities of calibration images, and
$${\hat{G}}_{Ti}^{*} = = {β}_{g} ( {T}_{i} ) ;$$
(4). calculating an error σᵢ between temperature self-test results \hat{T}(i, j) and true temperatures, namely temperatures Tᵢ, i=1, 2, . . . , N, j=1, 2, . . . . Mᵢ:
$${σ}_{t} = \sqrt{\frac{1}{n - 1} {\sum }_{i = 1}^{N} {\sum }_{j = 1}^{M} {E}_{i , j}^{2}}$$
(5). acquiring a RGB image, namely a test image Pₜₑₛₜ from a test workpiece in ultra-high temperature environment by using an industrial digital camera with charge-coupled device image sensors, denoting red channel value and green channel value of pixel (u,v) of test image Pₜₑₛₜ by R_{(u,v)} and G_{(u,v)} respectively, and calculating colorimetric value l_{(u,v)}:
$${l}_{( u , v )} = ln ( {R}_{( u , v )} / {G}_{( u , v )} )$$
(6). establishing an objective function L(G,T,l) based on Bayesian inference:
$$L ( G , T , l ) = \frac{{( G - {β}_{g} ( T ) )}^{2}}{2 {σ}_{g}^{2}} + \frac{{( F ( l ) - T )}^{2}}{2 {σ}_{t}^{2}}$$
where G is a green channel value;
(7). iteratively calculating a corrected temperature
7.1). calculating an initial temperature
$${T}_{0}^{t e s t}$$
based on the colorimetric temperature measurement formula
$${T}_{0}^{t e s t} = F ( {l}_{( u , ν )} ) ,$$
initializing iteration number k=1, green channel initial value
$${G}_{0}^{t e s t} = {G}_{( u , v )} ,$$
colorimetric initial value
$${l}_{0}^{t e s t} = {l}_{( u , v ) } ;$$
7.2). iteratively updating corrected temperature
7.2.1). calculating first momentum mₖ and second momentum vₖ:
$$\begin{matrix}{m}_{k} = {β}_{1} {m}_{k - 1} + ( 1 - {β}_{1} ) \frac{\partial L ( G , T , l )}{\partial T} \vert \begin{matrix}T = {T}_{k - 1}^{test} \\ G = {G}_{k - 1}^{test} \\ l = {l}_{k - 1}^{test}\end{matrix} \\ {v}_{k} = {β}_{2} {v}_{k - 1} + ( 1 - {β}_{2} ) \frac{{\partial }^{2} L ( G , T , l )}{\partial {T}^{2}} \vert \begin{matrix}T = {T}_{k - 1}^{test} \\ G = {G}_{k - 1}^{test} \\ l = {l}_{k - 1}^{test}\end{matrix}\end{matrix}$$
where β₁ and β₂ are momentum coefficients, the initial values of first momentum mₖ and second momentum vₖ are 0, namely m₀=0, v₀=0;
7.2.2). calculating bias corrections:
$${\hat{m}}_{k} = \frac{{m}_{k}}{1 - {β}_{1}^{k}}$$
$${\hat{v}}_{k} = \frac{{v}_{k}}{1 - {β}_{2}^{k}}$$
where \hat{m}ₖ is a bias correction of first momentum mₖ, \hat{v}ₖ is a bias correction of second momentum vₖ;
7.2.3). performing a temperature update:
$${T}_{k}^{t e s t} = {T}_{k - 1}^{t e s t} - {α}_{1} \frac{{\hat{m}}_{k}}{ε + \sqrt{{\hat{v}}_{k}}}$$
where
$${T}_{k}^{t e s t}$$
is k^{th} iteration's corrected temperature, α₁ is a learning rate of temperature update, ε is a constant which is used to prevent denominator from being zero;
7.3). iteratively correcting colorimetric value
7.3.1) calculating square sum
$${v}_{k}^{′}$$
of historical gradients through exponentially weighted moving average:
moving average:
$${v}_{k}^{′} = β {v}_{k - 1}^{′} + ( 1 - β ) {( \frac{\partial L ( G , T , l )}{\partial l} \vert \begin{matrix}T = {T}_{k - 1}^{test} \\ G = {G}_{k - 1}^{test} \\ l = {l}_{k - 1}^{test}\end{matrix} )}^{2}$$
where β is a weight smoothing coefficient, square sum's initial value
$${v}_{0}^{′} = 0 ;$$
7.3.2). correcting colorimetric value
$${l}_{k}^{t e s t} = {l}_{k - 1}^{t e s t} - {α}_{2} \frac{1}{\sqrt{ε + {v}_{k - 1}^{′}}} \frac{\partial L ( G , T , l )}{\partial l} \vert \begin{matrix}T = {T}_{k - 1}^{test} \\ G = {G}_{k - 1}^{test} \\ l = {l}_{k - 1}^{test}\end{matrix}$$
where α₂ is a learning rate of colorimetric value correction;
7.4). iteratively updating green channel value:
$${G}_{k}^{t e s t} = {G}_{k - 1}^{t e s t} + {α}_{3} ( {β}_{g} ( {T}_{k - 1}^{t e s t} ) - {G}_{k - 1}^{t e s t} )$$
where α₃ is a learning rate of update;
7.5). k=k+1, repeating steps 7.2˜7.4, until variation of the objective function L(G,T,l) before and after the k^{th} iteration is less that a set threshold θ:
$$L ( {G}_{k}^{t e s t} , {T}_{k}^{t e s t} , {l}_{k}^{t e s t} ) - L ( {G}_{k - 1}^{t e s t} , {T}_{k - 1}^{t e s t} , {l}_{k - 1}^{t e s t} ) < θ$$
or iteration number k reaches a maximum iteration number, then taking the k^{th} iteration's corrected temperature
$${T}_{k}^{t e s t}$$
as a colorimetric temperature measurement's output, namely a measured temperature.

2. A method for colorimetric temperature measurement in ultra-high temperature environment based on multisource error self-correction of claim 1, wherein establishing a colorimetric temperature measurement formula: \hat{T}=F(l) is:
heating the calibration workpiece by a blackbody furnace, and acquiring a plurality of RGB images, namely calibration images at i^{th} temperature Tᵢ, i=1, 2, . . . , N by an industrial digital camera with charge-coupled device image sensors in the process of heating, then establishing a colorimetric temperature measurement formula:
$$\hat{T} = F ( l ) = \frac{{c}_{2} ( {λ}_{g}^{1} - {λ}_{r}^{1} )}{l + {f}_{K} ( l ) + 5 ln ( {λ}_{r} \cdot {λ}_{g}^{1} )}$$
where \hat{T} is a measured temperature, l is a colorimetric value, F(l) is a temperature function of colorimetric value l, c₂ is a second radiation constant, λᵣ and λᵣ are standard wavelengths of red band and green band respectively, f_{K}(l) is a temperature response parameter function of colorimetric value l.

3. A method for colorimetric temperature measurement in ultra-high temperature environment based on multisource error self-correction of claim 2, wherein using the colorimetric temperature measurement formula to perform self-tests on the N pluralities of calibration images to obtain temperature self-test results \hat{T}(i, j)=F(l_{i,j}), i=1, 2, . . . , N, j=1, 2 . . . , Mᵢ is:
$$\hat{T} ( i , j ) = F ( {l}_{i , j} ) = \frac{{c}_{2} ( {λ}_{g}^{- 1} - {λ}_{r}^{- 1} )}{{l}_{i , j} + {f}_{K} ( {l}_{i , j} ) + 5 ln ( {λ}_{r} \cdot {λ}_{g}^{- 1} )} ,$$
$$i = 1 , 2 , … , N , j = 1 , 2 , … , {M}_{i} .$$
